(19) United States
(12) Patent Application Publication
(10) Pub. No.: US 2009/0089100 A1
(43) Pub. Date: Apr. 2, 2009

(54) Clinical information system

(76) Inventors: Valeriy Nenov, Los Angeles, CA (US); Xiao Hu, Los Angeles, CA (US); Cho-Nan Tsai, Los Angeles, CA (US)

Correspondence Address: LAW OFFICES OF CLEMENT CHENG, 17220 NEWHOPE STREET #127, FOUNTAIN VALLEY, CA, 92708, US

(21) Appl. No.: 12/286,043

(22) Filed: Sep. 27, 2008

Related U.S. Application Data
(60) Provisional application No. 60/976,718, filed on Oct. 1, 2007.

(51) Int. Cl. G06Q 10/00; G10L 15/00; G06Q 50/00

(52) U.S. Cl. 705/3; 704/235; 705/2; 704/E15.045

(57) ABSTRACT

A system, for interpreting information for a physician user or non-physician user, is described. The system includes a processing module configured to convert numerical data to at least one of a natural-language text and a machine vocalization. The at least one of the natural-language text and the machine vocalization describes a characteristic of the numerical data. The characteristic of the numerical data comprises at least one of a trend, a first derivative, a second derivative, a high value, a low value, and a time period, a pattern of repetition, an extrapolation, an interpolation, and a frequency. The physician user may enter data or receive data by voice alone through the backend database. The physician user may also order tests, labs or check on the same by voice alone.

This application is a non-provisional application claiming priority from provisional application entitled Integrated Clinical Information Phone Service filed Oct. 1, 2007, by inventor Val Nenov with provisional patent application No. 60/976,718.

### FIELD OF THE INVENTION

This invention relates to verbal communication over the phone with Electronic Medical Record Systems that contain patient information. In particular, the invention relates to a computerized system that features a virtual clinical information agent who has electronic access to a variety of clinical, radiological, hospital and other healthcare information systems and is capable of communicating information to and from such systems to caregivers including physicians, nurses, residents as well as the patients or their relatives.

### DISCUSSION OF RELATED ART

In clinical environments such as hospitals and physician's practices, the features commonly viewed by caregivers (physicians, nurses, residents, etc.) on computer monitors include text reports, images such as radiology scans, pathology specimens, graphs, trends, vital signs from bedside monitors, and many others which are used to present information on a patient's status on the Graphical User Interface (GUI) shown on computer screens.

Commonly, a computer monitor is used to mediate the transfer of information from a clinical information system (CIS), e.g., a database of electronic medical records (EMR), to a user. A caregiver seeking to remotely enter or receive information from the database either uses a computer screen or contacts a clerk who searches the database using a display interface, such as a monitor, and verbally conveys the information to the caregiver.

Nurses, physicians, clerks or other users of a CIS can be frustrated with a variety of persistent problems encountered while interacting with the CIS. Some of these problems stem from numerous shortcomings of certain existing CIS which consist of a web-based interface to the back-end data sources running on a multitude of wired or wireless, desktop, laptop or other Computer-on-Wheels (COWs). One of the problems is the users' lack of sufficient familiarity with the highly complex multi-screen GUIs with numerous nested menus which comprise a standard presentation layer of the CIS. As a result, it takes the average user a significant amount of time to log in and to navigate the systems to access or enter the vital signs of a single patient.

Another problem is the lack of familiarity with the hand-held computers which are used by some of the residents and clinical faculty. The relative slowness of these systems often causes additional frustration for the users. The Virtual Private Networks (VPN) which are used to increase IT security in most of the healthcare facilities add yet another level of complexity which hinders the information exchange workflow. People often do not know how to log on to the VPN in an efficient semi-automated way, which causes additional delays in their workflow.

CIS are designed to bring visual content in front of the eyes of caregivers in the form of text and various types of images, graphs and tables. The visual interface in itself is inherently a less-than-optimal interface between the humans' comprehension abilities and the back end computer databases where various types of patient information are stored. In their quest to understand the clinical status of a patient, caregivers often do not care specifically about the graphics, the images and the tables or other graphical controls shown on computer screens big or small. They mostly care about the actual information embedded in these means of presentation.

Most of the time, unfortunately the computer screens of the CIS are cluttered with data and the corresponding notes printed from these screens or filed electronically serve first and foremost the purpose of documenting the physician's or caregiver's activity. Such documentation is used to justify payment for service requests and justify the salaries of the personnel. Therefore its existence and management is not necessarily driven by concerns for the patients' treatment and well being but mostly by concerns for the bottom line.

Voice user interfaces are not new to the healthcare field. Numerous research papers, patents and practical commercial implementations have been done in the past fifteen years. Most of them have focused on solving the medical documentation problems faced by many clinical disciplines such as radiology, pathology and others. Automated voice transcription systems with exceptionally high transcription accuracy are commonly available today. Voice systems have also been used in controlling certain devices, especially those used in areas where the users need to have their hands free such surgery, ICUs, but also some clinical examination rooms and others. In addition to the domain specific applications of voice user interfaces, voice control of computer applications featured on the desktop and even handheld computers are widely available. Some of the related prior art is briefly summarized bellow.

The “Multitasking Interactive Voice User Interface”—U.S. Pat. No. 6,266,635 is implemented by the creation of a question and multiple answer set database. This interactive system is responsive to spoken words which are correlated with the previously recorded questions, commands or tasks. In a typical question and answer (Q&A) session this system enables a doctor to create a report during clinical procedures using prerecorded database entrees correlated with spoken words and commands.

“Graphical User Interface And Voice-guided Protocol for an Auscultatory Diagnostic Decision Support System”—US Patent publication number 20040092846 features an apparatus and method for determining an auscultatory diagnostic decision. The system assists listeners by implementing a voice guided protocol to record data and analyze results for the presence of heart sounds and murmurs.

“System And Method For Voice Access To Internet-Based Information”—U.S. Pat. No. 6,510,417 provides a method for voice access to Internet-based information and services including receiving a signal indicating a communication connection request in which the communication connection request is initiated by a user of a communication apparatus. The system establishes a communication connection with the communication apparatus of the user, receives voice information from the user, and communicates voice information responsive to the voice information received from the user.

“Automatic Dialog System with Database Language Model”—U.S. Pat. No. 7,424,428 features an automatic dialog system for spoken inquiries into a database entry which is capable of recognition of a spoken utterances for inquiring into the database. A language model which was prepared before a start of the dialog models the relative frequency of correlated occurrences of the components of the database entry provided for the inquiry in the spoken utterance of the dialog.

“Voice Controlled Business Scheduling System and Method”—US Patent publication number 20070168215 provides a fully automated, voice controlled business appointment/reservation system. The system has a natural language voice user interface that emulates a live office administrator for appointment/reservation bookkeeping. It includes an efficient availability searching mechanism which enables a telephone user to quickly search and reserve available time slot based on his preference.

“Adaptive communication methods and systems for facilitating the gathering, distribution and delivery of information related to medical care”—US Patent publication number 20060161457 describes automated methods and systems for persistently facilitating the timely gathering, monitoring, distribution and delivery of information related to medical care including: finding a communications channel for message delivery to a specific target person at a specified time; adaptively finding a targeted recipient; verifying that a recipient has actually received an attempted delivery within an applicable time limit; and automatically recognizing that an urgent message delivery-attempt was not timely completed.

Therefore while a number of strategies have been attempted in improving clinical information systems, the present invention has unique advantages not found in the prior art.

### SUMMARY OF THE INVENTION

Certain embodiments discussed herein disclose a method, a system and a service for gaining access to the CIS for the purpose of retrieving and submitting clinical information by care providers, patients, and other authorized users. This information is advantageously transmitted between the user and the CIS by the integration system using phones in the form of conversations between the user and the Clinical Information System. Unlike previous systems, this conversation is conducted in natural language (e.g. English, Spanish, etc.). The exchange is done in real-time much like a verbal exchange between two humans.

In certain embodiments, the system described herein uses the phone in a novel usage scenario, namely as a direct voice interface between healthcare providers or patients and the clinical, hospital and other information systems located on the premises of a healthcare facility. The system features a virtual clinical information agent which is designed to take a role in existing clinical information workflows and is centered at the point of care where it facilitates real-time verbal exchange of clinical data. The system is implemented as a virtual person capable of listening to care providers and patients and responding in a Natural Language, such as English or Spanish. The system has access to patient information records, such as electronic medical records, stored in information systems. It eliminates the need for common input and output interfaces, such as monitors, keyboards, and mice.

In one embodiment, the integration system uses commercially available, industry strength software packages for Automated Speech Recognition (ASR), for access to clinical databases, for text-to-speech (TTS) generation, and for advanced computer-based telephony. A special purpose software application developed on top of these software packages captures the essence, the content and the human verbal practices while dealing with clinical information. This software package contains novel and unique solutions for a Voice User Interface (VUI) design and implementation, which allows for reliable user authentication, patient selection, bi-directional verbal communication of patient-specific clinical information, and voice-driven instantaneous or scheduled paging, e-mail and SMS transmissions to third parties, which can be initiated by the user in the course of the verbal exchange with the Integrated Clinical Information Phone Service (ICIPS).

The advantages of using ICIPS are several, including no need of learning and mastering complex GUI-based systems, no need of relying completely and exclusively on computer monitors, including learning how to operate the associated devices, use of any phone at any time, and hands-free operation making the system easy to use while the user is in motion (e.g., walking, driving, doing manual operations like surgical procedures, etc.)

In certain embodiments, a method, for interpreting information for a user, is disclosed. The method comprises providing numerical data. The method further-comprises, with a machine, converting the numerical data to at least one of a natural-language text and a machine vocalization. The at least one of the natural-language text and the machine vocalization describes a characteristic of the numerical data. The characteristic of the numerical data comprises at least one of a trend, a first derivative, a second derivative, a high value, a low value, and a time period, a pattern of repetition, an extrapolation, an interpolation, and a frequency.

In certain embodiments of the method, the method further comprises taking a graphical representation of the numerical data, and converting the graphical representation to the natural-language text or machine vocalization.

In certain embodiments, a method, for using conversational or keyword-type voice commands to interact with an information database, is disclosed. The method comprises receiving from a user a voice command for retrieving a representation of numerical data. The method further comprises retrieving the representation of the numerical data. The method further comprises converting the representation of the numerical data to at least one of a natural language text and a machine vocalization. The at least one of the natural-language text and the machine vocalization describes a characteristic of the numerical data. The characteristic of the numerical data comprises at least one of a trend, a first derivative, a second derivative, a high value, a low value, and a time period, a pattern of repetition, an extrapolation, an interpolation, and a frequency.

In certain embodiments of the method, the method further comprises transmitting the characteristic to the user. In certain embodiments of the method, the user issues the voice command through a phone device, and the characteristic is transmitted to the phone device. In certain embodiments of the method, the numerical data concern a medical or physiological process or condition. In certain embodiments of the method, the method further comprises retrieving a graphical representation of the numerical data or converting the retrieved representation of the numerical data to a graphical representation of the numerical data, and converting the graphical representation of the numerical data to the at least one of the natural language text and the machine vocalization.

In certain embodiments, a system, for interpreting information for a user, is disclosed. The system comprises a processing module configured to convert numerical data to at least one of a natural-language text and a machine vocalization. The at least one of the natural-language text and the machine vocalization describes a characteristic of the numerical data. The characteristic of the numerical data comprises at least one of a trend, a first derivative, a second derivative, a high value, a low value, and a time period, a pattern of repetition, an extrapolation, an interpolation, and a frequency.

In certain embodiments, a system configured to use voice commands to interact with an information database is disclosed. The system comprises a receiving module configured to receive, from a user, a voice command for retrieving a representation of numerical data. The system further comprises a retrieving module, coupled to the receiving module, configured to retrieve the representation of the numerical data. The system further comprises a processing module configured to convert the representation of the numerical data to at least one of a natural language text and a machine vocalization. The at least one of the natural-language text and the machine vocalization describes a characteristic of the numerical data. The characteristic of the numerical data comprises at least one of a trend, a first derivative, a second derivative, a high value, a low value, and a time period, a pattern of repetition, an extrapolation, an interpolation, and a frequency.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements.

FIG. 1 illustrates system architecture for one embodiment of the integration system.

FIG. 2 illustrates samples of graphical trends of clinical time series data.

FIG. 3 is a chart showing possible voice functions.

### DETAILED DESCRIPTION OF EXEMPLARY EMBODIMENTS

According to one embodiment, the integration system may be accessed via telephone by dialing a telephone number assigned to the system, and talking to the system as if it is vet another human being at the other end of the line at the hospital. In certain embodiments, the integration system can then exchanged information with the caller, such as, but not limited to, patient demographics, visit status, clinical labs, vitals, reports, discharge, transfer and end of shift summaries, medications, clinical orders and any other information that can be conveyed verbally. Alternatively the integration system itself can initiate and outbound call to a caregiver and can engage the called party in a conversation about a patient who may need immediate attention. This call can be triggered automatically by predefined changes in patients' conditions which the system monitors continuously (e.g., scores like MEWS, APACHE and SAPS-2).

There are many advantages to the integration system (ICIPS). For example, the user of ICIPS does not need any kind of computer (desktop, laptop, handheld, etc.) or any fancy hardware, such as dedicated special purpose data capture or display devices. There is no need to learn how to operate a new software application since there is no “client” software not even a “thin” web-based client. There is no need to learn all of the features that the integration system offers. The user can just ask the integration system and be told in plain English what options there are and how to communicate with the system—as long as the user knows how to speak English and what clinical information he/she wants to exchange. The system can be operated hands free using a wireless headset or a speaker phone and provides access 24/7/365 from any location where there is a phone, thus providing an economical solution that ideally should not cost much more than a phone call.

The CIS stores patient information by using Electronic Medical Records (EMRs). When such information is required, the end user does not need to find another person like a nurse unit clerk to access the EMR and look up and read back information. Also, he/she does not need a computer screen to access such information. In one embodiment of the present invention, the end-user can personally talk straight to the EMR. In addition, there is no better or more humanly natural way to convey the information stored in the EMR than by means of Natural Language and human speech. In the framework of the present solution, it will be computer generated speech but it can be as close to human speech as possible with modern day text-to-speech technologies. And there is no other solution that practically eliminates all intermediate steps of people or computer screens dedicated to transferring or transforming this information from its source—the information system to whoever the recipient is (e.g., the doctor, the nurse, the resident, the patient, or the patient's relatives). This integration system has to be such that it allows for talking in plain English (or Spanish, or other languages) to any information system (IS), such as the CIS. This integration system allows for getting fast and efficient access to patient data.

In certain embodiments, using the integration system, an end-user can get data from the back end systems and can enter data. The interaction with the system is in a natural conversational way without the use of voice menus like “Say one for this,” “say two for that,” as implemented in conventional Interactive Voice Response (IVR) systems. In certain embodiments, the integration system eliminates the need of client software. There is only a server and the data comes to the user in a voice stream when needed so that she can get what she needs right away without having to wait while other irrelevant data is also coming down the channel. In certain embodiments, the integration system advantageously uses Voice User Interfaces (VUIs) instead of GUIs. The basic idea is to have more of “to-the-point” type of information available at the moment though a VUI rather than focusing on fancy GUIs overloaded with data.

In certain embodiments, the integration system increases the verbal communication with backend systems rather than putting a layer of visual presentation between the user and the data stored at the backend system.

Methodology and Relevant Technologies

In certain embodiments, the methodologies and technologies used by the integration system fall into several categories. One is the knowledge of the current verbal information exchange practices among patient care givers working in the clinical domain. When nurses and doctors exchange information about patients they use a domain specific set of verbal expressions and conversational templates. In certain embodiments, the integration system captures this type of linguistic knowledge and embeds it. In certain embodiments, the caregivers' verbal experiences are incorporated into the integration system design. In certain embodiments, the integration system contains an Automatic Speech Recognition (ASR) component and a Text-To-Speech engine (TTS). In certain embodiments, the integration system is configured to have integrated access to the back-end clinical data sources of the healthcare facility. It can be hooked to the telephony system and can be managed by the “Call Center” of the hospital.

In certain embodiments, various types of commercially available Speech Recognition Engines can be used by the integration system, such as, but not limited to, speech recognition engines by Nuance (Dragon Naturally Speaking), Philips (SpeechMagic), AT&T, IBM, and Microsoft (Speech Server 2007). The selected engine should provide workflow tools for building domain specific grammars, as well as be scalable.

In certain embodiments, the integration system also features an Interactive Voice Response (IVR) component, which is a sophisticated voice processing application that creates an interface between persons and computer databases using a touch-tone telephone.

System Architecture

In certain embodiments, the integration system contains an Automated Speech Recognition (ASR) system coupled with Natural Language Processing (NLP) and Text-To-Speech (TTS) generation modules. The integration system consists of software and hardware components.

The hardware includes standard off-the-shelf computers and computer boards (such as the Dialogic® 4000 Media Gateway Series). The computers function as servers connected to the hospital networking infrastructure. In addition, in certain embodiments, the integration system utilizes digital or analog telephony cards connected to the Hospital PBX and the PSTN at large. In certain embodiments the users can access the integration system through any kind of phone including cell, car, VoIP, desktop, etc.

The software components include a Speech Server, a SQL database, such as SQL-2005 from Microsoft, a software development environment, such as the Microsoft-Visual Studio 2005, Telephony Interface Management (TIM) software, and/or Voice over IP (VoIP) software, and software for communicating patient data from and to the hospital EMR such as HL7 parsers and generators, Web Services with WSDL, and others.

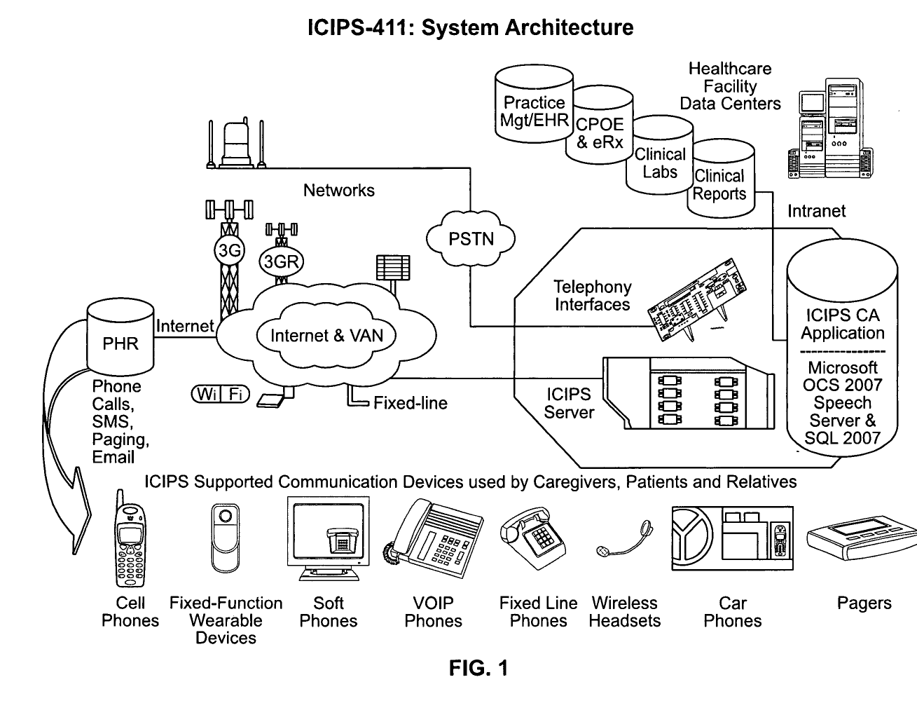

FIG. 1 illustrates system architecture for one embodiment of the integration system.

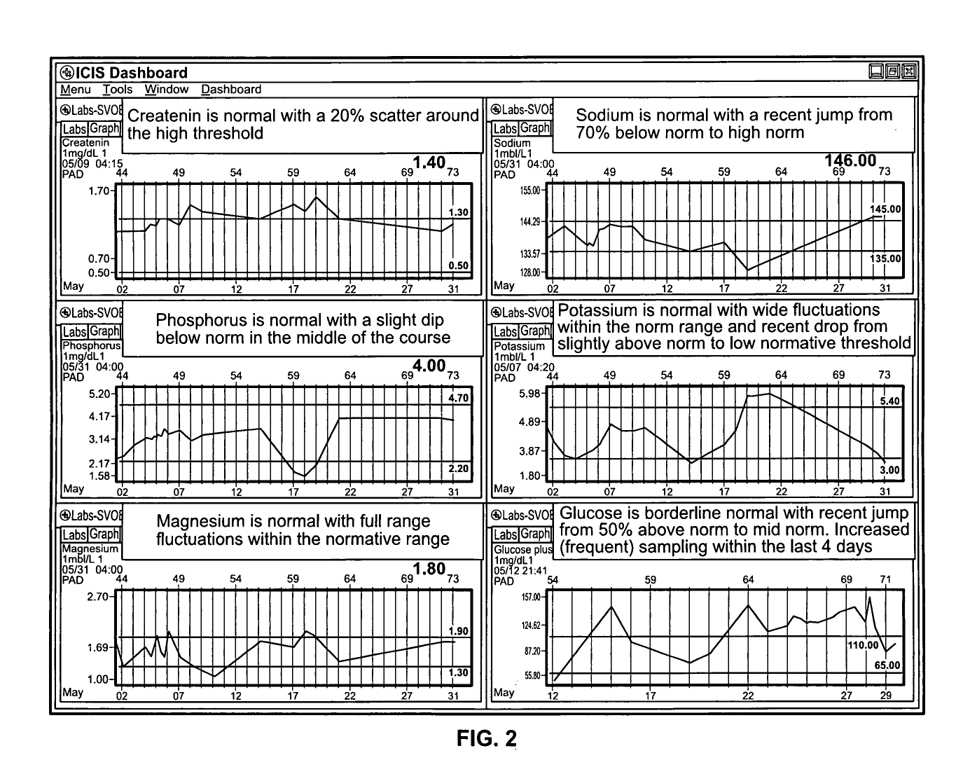

In one embodiment, the integration system describes trends with the guideline that a clinically accurate description might be such that if you tell the description to some one and ask them to draw the trend, following your description they can draw a trend that captures all the clinically relevant aspects and is very close in appearance to the original trend that you described. FIG. 2 illustrates samples of graphical trends of clinical time series data, along with examples of associated descriptions of the data provided by the integration system that may be vocalized.

Another significant scalability issue to deal with is patient search. In certain embodiments, after authentication, the integration system can provide a voice user interface for locating a patient. A common issue in solving this problem is that there might be thousands of patient records in an EMR. In certain embodiments, the integration system uses various constraining factors to help locate a patient, such as the date the patient was admitted (ex. “the patient was admitted yesterday”), diagnosis, the admitting physician, and the location in the healthcare facility (ex. ER, ICU, etc.). In certain embodiments, the integration system can find a patient by, for example, location in a hospital unit and bed, by room and bed number, by medical record number, and by first name and/or last name. To facilitate the patient search the integrations system keeps a profile of the user (physician, nurse, etc.). This profile contains information such as the users list of patients. When the user logs into the system the profile is automatically loaded in the background and based on it the system generates dynamic grammars which containing profile specific information such as current and past patient names. This process dramatically facilitates the patient search by constraining the search space.

Another component of the integration system is clinical data access. In certain embodiments, once the integration system gains access to the data, the system packages the data so it can be delivered promptly to the end user. In some instances only data specific to the current patient context is captured and made available. Data packaging (pre-processing) depends on the nature of the data. For instance, if a radiology report is very long physicians will most probably not care about all the details (especially in the methods section, which commonly repeats from report to report) so consequently integration system might not have to read back the entire report. Doctors often do not care to read entire reports written by their colleagues like for instance radiological reports. They are often interested only in the finding since they already know the standard method, which was used to produce the scans on the first place. They care about the conclusion, so the system should be able to parse the text or at least segment it in distinct paragraphs and provide direct access to the requested in formation. This is true for many documents filed electronically that often contain a lot of standard content which is necessary for record keeping but is not necessary for day to day operations.

In many situations the electronic data is not in textual format. It may be in the form of numerical time series like vital signs or labs or images like CT or MR scans or pathology slides of frozen specimen sections. One can have automated means to summarize such types of non textual data in the form of verbal statements and say for instance: “this is going up |is constant| is unchanged” “this is going down”, “this is normal and has not changed”, etc. Such types of summaries are actually the job of specialists such as pathologists, radiologist, etc. In certain embodiments, what the integration system and most non-specialty physicians, nurses and other care givers are interested in are actually the results of their work—the reports themselves that can be piped through a voice channel.

One of the important issues in front of the integration system is that of patient privacy and confidentiality. In certain embodiments, the integration system features means for authenticating the caller, such as by means of user accounts, passwords, Personal Identification Numbers (PINs), etc.

Major Design Features

In certain embodiments, the information transmitted over the phone between end-users and the hospital/clinical/radiological or other information systems through the integration system is patient specific. In certain embodiments, the integration system provides both historical patient information, like the patient's past medical encounters, but also timely, up-to-date, near real-time patient-specific information, which is relevant and critical to the current patient status and the ongoing patient treatments. The data modalities which are exchanged are very diverse, vitals, scan reports, end-of-shift summaries, labs, etc. The language in which patient data exchange is done is plain conversational Natural Language such as English (the default language) but also Spanish, French, German, Chinese and probably a dozen natural languages. This is only limited by the speech engine which is used at the back end. For example, the latest Microsoft Speech Server 2007 (OCS-2007) supports up to 7 different languages. Other commercially available ASR/TTS platforms feature additional languages and variety of quality voices

In certain embodiments, the integration system targets a broad audience, which will include nurses, doctors, patients, their relatives and other care providers. In certain embodiments, the integration system is a versatile application which can deliver different functionality to different segments of users while still embodying the conceptual design of being a virtual person representation (or in other words a VUI interface) of the entire CIS. In addition, in certain embodiments, the integration system is configured so that the verbal information that it delivers over the phone is user specific and patient specific and takes into account the users' access privileges and the access restrictions to patient's data set by or for the individual patients. For instance, physicians may have access to all of their patient's information while the patient's relatives might be restricted in some ways, but patients may impose additional access restrictions and so forth.

Virtual Clinical Information Agent

In certain embodiments, the integration system embodies a conceptually novel user interface to common information systems. Specifically, integration system offers the IS a virtual personality which is embodied into a silent or active assistant in situations when you have an encounter, such as between a patient to doctor, a patient to nurse (caregiver), a caregiver to caregiver, or a caregiver to patient's relative, which requires information exchange about a specific patient which can be captured or is already in electronic form and needs to be conveyed to one or both participants of the encounter. In certain embodiments, the integration system can capture the essence of this conversation on the fly and record it properly. For instance in the case of writing down an End of Shift Summary (EOSS) by a nurse, with the integration system the nurse will not need to remember and record all relevant clinical highlights at the end of the shift but she can do it as she goes and this way the information available to other parties will be up-to-date at any time.

In certain embodiments, the integration system allows the user to dictate her observations as she goes with no need to remember details or the order of things. This way the user ends up with a more accurate time-stamped log of each entry and when the user is done with her work shift or the operation or procedure which she was doing, she is simultaneously done with the necessary documentation. And her cumulative report is available in near real-time to other parties that might need access to it. This approach can be seen as a complete paradigm shift that might not be welcomed by all users especially those who might want to “doctor” the report or to omit parts of it that might not be “comfortable” to report for one reason or another. Such report can be further used to analyze the performance of the user or the caregiver from the temporal perspective and can serve as the factual basis for optimization of such performance.

In certain embodiments, the integration system in a conference call or patients' rounds scenarios allows multiple users to log in at the same time and supports a conference call or round table type of discussion. An example of this is during patient rounds. Users can say “This is Val” or “This is Neil talking/speaking” to “capture the floor”, which sets the Current User in integration system working memory. Consequently, in certain embodiments, the integration system can refer to the current user by name when answering questions. In certain embodiments, the integration system can keep track of the users questions so that it can intelligently switch to the users context when the current user changes. The system can recognize the voices of the participants as they take turn speaking and correctly attributes the verbal statements made during the rounds to the caregivers who made these statements. In cases when people talking at the same time, other means for facilitating the speaker recognition process can be applied ranging from private voice input devices (separate phones and personal microphones) to algorithms for solving the “Cocktail Party Effect”.

Methods

The solution provided by the integration system involves some methods that come from the field of Natural language Processing (NLP). Specifically it uses semantic and syntactic parsing and context based disambiguation. For instance, ICIPS-RAD (the radiology module of the integration system) parses the verbal description of the scan request into three semantic components (organ, scan type and details). This approach is necessary and better than directly selecting one of the usually more that 2400 different scanning protocol options because users can not easily remember the exact verbal descriptions for each of these options. Specifically, they may not remember the order of words in those verbal descriptions. This makes automated recognition of their verbal orders much more difficult. Their verbal requests can be incremental—a word or a concept at a time and only a conceptual representation coupled with the appropriate parsing featured by ICIPS-RAD can deliver satisfactory results. Furthermore, ICIPS-RAD assembles the pieces of the request into a final code which maps exactly to one and only one of the scanning codes available in commercial Radiological Electronic Order Entry systems such as IDX.

Secure Modes of Clinical Data Communication

Common modes of clinical data communication include speech, pagers, phone calls, emails, taxes, and text messages. In certain embodiments, the integration system employs all of them in the out-bound direction and some of them in the in-bound direction. For outbound contacts with users, it is up to the users to decide which of afore mentioned modes integration system can use to contact them. In certain embodiments, the integration system is designed to collect and store all necessary contact information, and if some phone number or pager number is not in the database, the integration system asks the user, such as when they request to be contacted or to contact another user. More than one way of communication can be done in parallel by integration system on user's request. For instance, if the user says “Contact me (urgently) when the CT scan for patient ABC is available” without specifying a specific communication mode, then integration system chooses either the default mode set by the user or all available modes at the same time if the request is urgent to assure that the user gets the message.

In certain embodiments, all of these modes of communication with integration system can be used in both directions—to SEND or RECEIVE communications from the integration system. In other words, even though integration system is basically a phone service, the same functionality can be achieved by all other modes of communication where the only limitations are those due to the bandwidth restrictions of each mode. For instance if the user can send a SMS to integration system and ask to be SMS (TEXT) back with some info about some patient.

In compliance with the numerous guidelines for protection of the privacy to the patient health information (e.g., HIPAA, JACHO, etc), in the design of integration system, particular attention has been paid to security and privacy related issues. ICIPS is designed to maintain the communications in any of the modalities in compliance with the guidelines and restrictions pertinent to the specific communication type.

Voice Data Persistence

Voice communication has the problem of “lack of persistence”. Once a person says something (unless recorded) it is gone and it does not stay on a screen or a piece of paper to be available for reference at a later time.

One solution to the “lack of persistence” problem for the voice communication mode is to have immediate real-time access to any and all bits and pieces of the data. Humans in their day-to-day verbal communications are accustomed to not having persistence information in front of them. For many generations humans have not been using notes and computerized presentations all the time when they communicate, and while having notes can guide humans' communication and make it more efficient this might not be always necessary for simple and short exchanges which constitute the majority of the daily exchanges by health care providers. Even in the highly orchestrated and optimized by means of notes (on paper or screen) physician's rounds to patients, one can find (upon careful examination of the workflow) that the notes are mostly used for documentation purposed (to justify the pay for service) but are not necessarily efficiently used for the actual patient care. This statement is not out of the blue. We have carefully documented many cases of information exchange between care givers during rounds and have used the acquired knowledge about the IT workflow not only to justify the potential usefulness of integration system in this process but also to guide our design of the conversational patterns that are embedded in integration system to support the patient rounding workflow.

In certain embodiments, the integration system has many advanced features and one of them is the personal customization of its verbal behavior. In certain embodiments, by design the integration system is supposed to verbally behave as a nice, reasonable, friendly mature and very informed female who speaks English (or other languages) and who can carry a conversation in mostly a Question/Answering (QA) mode, where the questions are all geared towards getting or giving patient specific information. The varieties of dialogs which integration system can be engaged in are modeled on regular human conversations about particular patient data. In addition to the “learn by listening and trying to talk” method of learning how to communicate with integration system, in certain embodiments, one can actually ask the integration system about how to communicate with her. In essence, in certain embodiments, the integration system can teach a novice user how to talk to it. It can also describe all the data services that it can offer. The user just needs to ask, for example, “what services do you offer?” or “what can you do for me?” or anything conceptually similar. This is a practical implementation of the well know in the computer industry “online help.”

Examples of Usage Scenarios

Numerous usage scenarios were considered in the process of designing of ICIPS. The overall objective was to identify clinical information exchange situations which can benefit of using ICIPS to provide a “digital pain killer” that can be delivered over the phone.

The modular architecture of integration system provided access to: 1) Electronic medical records (EMR) stored at the UCLA Medical Center's Patient Care Information Management System (PCIMS), 2) Real-time vital signs and specifically vitals parameters stored in the nursing documentation system, 3) Clinical notes/rounding lists generated by ICIS (a product of Global Care Quest, Inc.), 4) the Radiology Information System (RIS) which stores all radiology reports, 5) Clinical Laboratory results and other custom data types, and 6) the IDX Radiology Requests Order Entry system—a web-based interface to the clinical scanners, and other similar data sources.

Scenario #1: Mandatory and User Requested Notifications

Notifications, in general can be classified as 1) Mandatory (on the part of the notifying person)—they are required by the policies and practices established at the facility; and 2) Requested (on the part of the notified)—they are initiated by the potential recipients and their purpose is to enable the recipient to do his/her job properly. In both cases notification can be originated by some person or by a clinical IT system. The most common means for delivering of notifications are: verbal, phone, e-mail, fax, SMS, and on screen messages.

In this study we focused specifically on the category of “Requested” notifications. The primary objective was to evaluate 1) the functionality, usefulness and user-friendliness of the voice interface to a backend notification system and 2) to design, implement and verify the functionality of such a system.

Practical examples of the need for “Requested Notifications” include:

An anesthesiologist working in the operating room may be waiting to start the case until he gets a certain lab value back. So he can call integration system and say “Page me when the Potassium test is done”.

When a patient is taken from the operating room to the recovery room the anesthesiologist needs to be notified about the Hemoglobin level in recovery or if the blood pressure (BP) goes below a certain point.

In the ICU, a physician may want to be notified when the patient's intracraneal pressure (ICP) goes above 15, rather than depending on the nurse picking it up and paging him,

Practical examples of “Mandatory Notifications” can be found, for example, if one looks at quality improvement and performance measures. It is essential to notice that every patient who gets admitted to the hospital have a statement in the admissions order chart that says “Notify house officer if the systolic BP is less than 90, HR greater than 110, Temperature grater than 39.0.” These orders are meant for the nurses. However, the nurses don't always follow the orders or do not follow them as soon as they identify the condition and some times it is very important to notify the appropriate party ASAP. For instance, after thyroid surgery it is important to have adequate blood pressure and to notify the house officer when the BP systolic goes over 150.

The issue sometimes is that the nurses do not know who the house officer is or how to reach him. Who the house officer is depends on the service. For some services the page operator has the list or there is a list of who the attendings on call are or who the residents are. For important things the chief resident has to be notified, but for minor things like temperature one might want to call the resident.

In a study of performance or outcome measures like critical ICP or CPP value one can show a better response or notification liability and compliance with an automated system for notification than with a conventional human notification system that has steps that may get followed eventually and eventually may mean after a long time. In ward care the nurses are the interface between the doctor and the patient but may not be always there to determine when there is something that needs to be communicated to the doctors.

On a pain service what frequently happens, is that the anesthesiologist on call at night does not hear anything about a patient and the next day he finds that the patient has been nine out of ten pain for the past six hours but no one has told him even though the observation has been entered in the nurse charting system (e.g. Essentris by Clinicomp). Or he sees that the blood pressure has been dropping and he would have wanted to do something about it but no one told him.

In a similar situation, very often an anesthesiologist comes in after the first day of surgery when the patient is starting an epidural therapy and finds out there has been a problem but he was not notified. Anesthesiologists want to be notified automatically any time when the pain score goes above 4 out of 10 so they can call the nurse and ask what's going on.

Another similar scenario plays out in a service like consultation on acute pain. The pain service makes recommendations, but the primary service let's say that it is surgery, makes the orders. But the consultants do not know if something got done in response to the recommendations, so that they can make further notifications or need to come and see the patient.

In order to achieve a reliable notification system the first step is establishing of reliable data capture systems. In the case of medications, the nurses fill out the Medication Administration Record (MAR) by hand in the patient's paper chart. There is a list of medications that can be accessed electronically but whether the medications were actually given is not captured in the system. Typically, only infusions such as IV TPA are charted electronically but the occasional single medication orders are not charted electronically

For the anesthesiology interface some people do not capture data on the spot by the bedside but will do it after. The recent clinical events the physician's impression and the plan have to be done by some text capture. Integration system might be too slow for this particular function.

In certain embodiments, the integration system advantageously tests and matches the criteria in Clinical Trials Patient Enrollment when new patients are admitted. In certain embodiments, the integration system can set a permanent notification script to run periodically in the background and look for new patient admissions with specific disease or some keyword in any of the reports or database fields. This can be done on a case by case basis until a somewhat verbally manageable set of criteria can be created so that the choice selection can be done by phone request to integration system.

Scenario #2: Routine Vitals Data Capture by Nurses on the Ward

Improved means for data entry in the EMR is a constant topic of discussion in the Clinical IT community. Besides verbal data presentation to the end user, integration system provides the means for data capture. For instance it can be used to eliminate the need for nurses to write down the vitals when they examine patients which is routinely done during patient visits several times a day in the course of a regular nursing shift. Besides vital signs, integration system can also capture and document other clinical events. For example, a nurse oriented handheld wireless device can be carried by nurses when they go to patient rooms to check on the patient's status including measuring the vitals. The nurse basically reads out the data from whatever portable or wall mounted bedside monitors are available in the patient's room and enters the data by punching the numbers on the keypad of the device. The types of data entered are very basic. The device electronically captures vital signs at the point of care. In certain embodiments, this functionality can be easily provided by the integration system with out the need for introducing a special purpose devices, which comes along with all of the risks and inconveniences related to the management and operation of such devices including, wireless connectivity, lost/theft, user training, extra cost to supply the staff with such devices and most importantly the very narrow applicability of these devices, which can be very expensive (a few hundred dollars per device). Wireless phones are often already in use by nurses in many hospitals or if there are no such phones, then regular phones located by the bedside in patient's rooms are almost standard in all US hospitals. In certain embodiments, they can be easily used to access the integration system.

In one example of how data is captured by the integration system, a nurse goes into a room, contacts the integration system on the phone and tells which room she is in. In certain embodiments, the integration system reads back the name of the patient which the nurse verifies on the patient hospital admissions bracelet. The patient date of birth can be also verified after this initial “handshake” protocol is completed. Then the nurse reads the vitals aloud directly from the monitors while integration system captures and records the data directly into the CIS along with a time stamp as well as the name of the nurse who mediated the data capture. While special purpose hardware can get obsolete in a short period of time or get broken or stolen, the standard phones in the patient rooms have a very long live expectancy and since they are used for many other purposes, there is a good chance that they will be kept operational and fixed, replaced or upgraded when needed. In addition many nurses carry wireless hospital phones which can be used for the purpose of data capture at the bed side. Finally, as compared to other approaches in which the data is captured automatically from the bed side monitors, this approach guarantees that the data is verified by the nurses and is artifact free before verbally entered in the CIS.

In certain embodiments, with the integration system, the nurse can speak on the phone what she sees displayed on the monitor and integration system can read the recorded data back for the nurse to verify. Consequently, there is no need for the hospital to buy a large system with a lot of dedicated software and hardware to do something that can be done over the phone in a much simpler and cost efficient way.

Not all nurses on the ward carry mobile wireless phones but all of them have access to house phones in the corridor or at the nursing station or to the patient phones in the patient rooms. One concern about the usability of integration system that was expressed is that different users have “different verbal skills.”

Scenario #3: Self-assignment of Clinical Roles

A hospitalized patient is commonly taken care by a team of caregivers which commonly includes a nurse, an attending physician, a nutritionist, etc. Some of these roles are more permanent than others. Some are assigned and de-assigned several times a day. Often the record on which person is filling which role is loosely maintained on or by a computerized system and the responsibility of maintaining this record is given to a unit administrator, the charge nurse or the unit clerk. The person filling the role is often verbally notified and often there is no written record of when and if this person assumed this responsibility and when he/she was relieved of this responsibility. While some of the roles might be temporary in the sense that they are not life-critical it is important that all essential roles are filled at al times. Some time however there are obvious gaps in the roll assignments, which can lead to adverse events. In some more advanced hospitals nurse instead of using punch cards to sign in and out are using electronic swipe keys or smart cards.

In certain embodiments, the integration system can help by providing a self-assigned/relieved role management function. Simply stated, a caregiver calls the integration system and says, “This is Jane Doe. Today I am the nurse for patient John Doe”. In the background integration system, verifies her eligibility, matches the assumption of the role with the assignment made by the charge nurse (which might have been propagated to the nurse by page or other means), notes the time, etc. From this point on and until the end of the nurse's shift when someone wants to talk to the nurse he can just call the integration system and ask to be connected to the her and there is no need to know her name or contact information since it is already in the system.

A user than can call integration system at any time and ask “Who is currently on the patient care team for patient John Doe?” He can also reach individual members by calling their roles without knowing their names.

Different clinical facilities will have different team members depending on the specialization of the facility. Consequently the number and diversity of the roles played by the team members will differ as well. The framework or the schema of the system however does not change conceptually and can be adapted to the needs of different facilities easily.

In certain embodiments, the integration system can be used by staff to sign in and out every day in a particular role and change the roles. For instance, after finding a patient the user can say, “I am his nurse today” and the integration system will know that for the rest of the shift this is the nurse to contact if someone required information about the patient, or if necessary to send some automatically generated reminders or orders. A user can inquire about a patient and can say “can you ask his nurse to call me” and leave a phone number and a name.

Scenario #4: Integration System Assisted Patient Rounds

Patient rounding by a patient care team lead by a physician is a common practice in all health care: facilities. In an 8 bed ICU it usually takes an average of 45 minutes a day for a resident to prepare all information necessary for the patient rounds. This includes reviewing paper charts, checking labs and vitals on the nursing documentation system which can be electronic or on a paper chart. During the actual rounding process however, the physicians, residents, bedside nurses and variety of technologist exchange significant amount of patient related information among themselves which is normally captured on paper as side note scribbles and on some occasional bedside electronic data capture systems. As a result there is no immediate availability of good working documentation after the rounds are over. The notes need to be transcribed and entered in the patient record as observations or orders and often acting on these orders is unnecessarily delayed.

In certain embodiments, the integration system provides a real-time voice enabled data (observations, orders, etc.) capture system which feeds the data straight into the EMR, categorizes it appropriately, identifies the author of the record and time stamps it. Several detailed studies of the information exchange among members of the patient care team during morning rounds in the UCLA neurosurgery Intensive Care Unit (7W-ICU) were used as the evidential basis for designing of integration system patient round assistant component.

Scenario #5: Voice Interface to a Radiology Request/Information System (RIS)

Computerized Provider Order Entry (CPOE) systems have been for years one of the hot topics in the Healthcare Information Technology field. Commonly such systems are used for placing electronic orders to the pharmacy, the clinical labs, the radiology department and other ancillary services. Some CPOE systems feature GUIs implemented as “thick client” while others are web-based “thin client” systems, which allows the user after proper authorization and authentication to enter the necessary information on-line in order to place an order. This information includes the patient name, DOB, MRN, and service, the names of the attending and requesting physician(s) and their contact information (phone, fax, pager numbers), and most importantly the radiology request itself which includes the anatomical area that needs to be scanned (e.g., head, neck, chest, pelvis, extremities, etc); the type of scan (e.g., CT, MRI, XR, CTA, US etc.); any additional information pertinent to the scanning procedure (e.g., contrast, approach, etc.) and finally, the reason for this study (e.g., evaluate for stroke, look for kidney stones, etc.).

In practice, in most of the hospital departments where the CPOE web-based system is not accepted, the process of placing and executing a radiology request involves several steps. First the physician fills up and signs one page standard request form, this form is taken by a nurse or an office clerk and faxed to the Radiology services. A lead radiology technician enters the data from the faxed form into the web-based systems. Once in the system the order is placed on the work list of the appropriate technician who executes the order depending on its priority, the availability of the scanner, the time of day and day in the week, etc. Only after that the images are posted for viewing on the Web-based image viewing system (e.g., Centricity by GE). Once the images are available a radiologist has to find the time to review them and to write a report which is also posted online. The final step is for the requesting physician to go on-line and review the report.

There are several places in this workflow where the system can fail or get significantly delayed. First is the step of writing down the order on paper and faxing it to radiology to be entered in the system. The involvement of people (nurses, radiology technologists, clerks, etc.) and equipment (fax—a verbal phone order directly to Radiology is usually not acceptable due to the requirement for a “paper trail” and signature) can cause significant delay. Once the faxed order is in the hands of the lead radiology technician it commonly turns out to be incomplete or questionable which requires the technician to place a call back to the requesting doctor to clarify or verify the request. The main reason for incompleteness is that there are more than 2500 different scanning protocols that the IDX system is designed to accept and fulfill and doctors commonly do not know exactly what to choose. The choice between a handful of options for any particular type of scan and organ is left to be made by the technician based on the information in the scan request itself and the reasons for this request stated on the form.

One of the ways to relieve this initial bottle neck is to ask the doctors to fill the forms on-line and make the choices themselves. This approach however has seen significant resistance on the part of the physicians. The main reasons for this reluctance have been: 1) it takes a lot longer to fill an on-line form than to rapidly scribble few lines and mark a few check boxes on paper. 2) The design of the forms is not optimal. It does not conform with the accepted windows form design standards, which makes navigation difficult and time consuming—things in the forms are not where users expect them to be. 3) Often some fields in the form, which should and could be pre-populated from other online data sources are left to the user to fill in manually, which is an obvious waste of time and source of user frustration (no one likes unnecessary paper work). Such fields in the case of the radiology orders are actually all of the fields except for the request itself (organ, scan type and details) and the reasons for the scan. All of the remaining fields can be filled in automatically.

Finally, searching for the right scan code (the number which uniquely identifies the procedure to be performed) is also a frustrating experience which requires learning and patience. This is also one of the reasons why doctors do not like to fill out these on-line forms themselves and rather get a call from the radiology technician and talk it over.

In certain embodiments, the integration system with its unique VUI and its intelligent back end can solve most of these problems and save significant amount of time and eliminate user frustration and reluctance. The way it can accomplish that is by 1) pre-populating all of the fields that can be filled-in automatically; 2) accept the order in the form of a verbal description which creates in the backend the appropriate code; 3) submits the order directly from the physician to the IDX system without the need for paper, for nurse, fax, and technician. In addition, is provides real-time order verification and automatic notification by means designated by the requesting doctor (page, fax, email, call) when the order is fulfilled and the images and/or the report are posted.

Scenario #6: Medical Emergency Data Secure Integrated Phone Service (MEDSIPS)

Companies who run ambulance services or the state or city controlled Emergency Medical Services (EMS) which includes ambulances and fire engines focus mostly on communications between the emergency vehicles and a central dispatch station. The main purpose of their computerized dispatch systems is to deliver prompt and efficient service to their customers. Commonly, computer-aided dispatch systems feature mapping programs for tracking of vehicles which enables them to locate the closest available unit to dispatch and provide prompt response times. Ambulances are often equipped with Automatic Vehicle Locator (AVL) to accurately track the vehicles location and status. Emergency vehicles transmit status indication signals such as: “responding,” “on scene,” “leaving scene,” “destination,” “clear,” and “emergency”. The central stations and the vehicles maintain direct radio contact with state and local police and fire agencies to provide and coordinate responses when needed. Enhancements, such as better navigation systems, electronic patient records and automatic vehicle location, can be added as more advanced wireless digital communications systems are introduced. Some of the standard components for mobile ambulance communications systems include:

Computer-Aided Dispatch (CAD)

Mobile Data Terminals (MDT) for status messaging technology

Alphanumeric radio paging for last, accurate dispatching of assets

Digital voice recording with rapid search capability

Global Positioning Systems (GPS) & Automatic Vehicle Locators (AVL)

Reliable, scalable and rugged voice radio communications systems.

Handheld, digital patient care systems (sensors, monitors, BT connected, etc.)

The communications between emergency vehicles and the receiving Emergency Centers are often not well developed and as efficient as compared to the communications between the ambulances and the dispatch centers. Even though emergency responders are often capable of identifying the victim on the spot, this information is rarely used to check for the existence of other medical emergency information at the receiving hospital or at other healthcare facilities in the region where the victim might have an already established medical record. A patient-specific emergency data set which may/should include: prior medical history, known allergies, blood type, current known medications, insurance carrier, etc. can be very valuable for the immediate treatment of the victim at the scene of the accident as well as during the transportation to the Emergency Room. It can also have an effect on the choice of the receiving facility. This type of data unfortunately takes a long time to obtain and transmit to the ambulance since it requires a person at the receiving center to do a computerized search to determine if the victim has a record in the hospital EMR. Even if such record is located, timely transmission of the relevant Minimal Emergency Data Set (MEDS) is impractical due to the lack of appropriate communication channels.

One embodiment of the integration system, MEDSIPS, fills in this gap. It requires that the main emergency centers in an urban or rural region are equipped with MEDSIPS servers connected via HL7 and/or Web Services to the affiliated hospital's EMRs. Each hospital-based MEDSIPS server has back-end database connectivity to the remaining EMRs in the participating hospitals (ERs). This is to insure that a parallel search of all participating EMRs can increase the chance of locating the victim's electronic medical record. Of course, the victim can provide such information himself (i.e. which hospital/doctor she/he goes to) which will simplify the search. Ambulances carry cell phone(s) with good coverage in the area of operations. When the ambulance arrives at the scene the technicians try to obtain as much identifying information from the victim as possible ether by verbal interrogation if the victim is conscious and able to talk and, from ID(s) that the victim carries or from witnesses. A minimal data set, which is sufficient to locate electronic patient's records in the local area receiving facilities through MEDISPS, can include: First and Last name, and the Date of Birth (DOB). Additional information, such as gender, SSN, ethnicity, address, phone, etc., if available, can be used to further verify the identity of the victim. The EM technician picks up the phone and calls MEDSIPS. Note that all technicians are given MEDSIPS accounts accessible by name and PIN. After logging on MEDSIPS the EM technician asks for the “victim identification” function and speaks the patient ID information. MEDSIPS identifies the victim and offers to read back the relevant MEDS.

During the course of transportation to the EM center, the technician maintains an open phone channel with MEDSIPS (which can be placed on hold if necessary) and from time to time speaks aloud the vital signs measurements displayed by variety of on-board patient monitors. These data points are directly recorded by MEDSIPS and are made available to any one who needs to take care of the victim upon arrival. The ER technician has the option to verbally request MEDISPS that the Emergency response team at the receiving facility is paged/SMS-ed/E-mailed or automatically reached by parallel outbound phone calls made by MEDSIPS to the team members. He can specify what part of the victim's MEDS is conveyed to the team. The technician also has the option to record voice messages to the ER team, which can be asynchronously retrieved by the team members at their convenience. All of these communication transactions are time-stamped and logged by MEDSIPS for later audit if necessary.

MEDSIPS can serve as a virtual human operator and medical records clerk which is available 24/7/365 and can attend to multiple simultaneously occurring emergency situations throughout a wide urban and rural area. By providing bidirectional flow of patient-specific information between emergency vehicles and the receiving emergency medical facilities it can improve the quality of provided care as well as the speed and accuracy with which the victim is treated. While it is inexpensive to implement since it uses off-the-shelf technology such as standard cell phones, it can potentially save lives and save money.

Scenario #6: Direct Order by Voice Entry (DOVE).

In hospital settings clinical orders including orders for medications, labs, and variety of test are commonly written down by the attending physicians in the patients' charts of entered via computer monitors (keyboards and mice) directly into the corresponding electronic medical record systems. Clinical practice shows that medication orders are one of the most error prone orders. Problems with written conventional medication orders have been heavily researched and documented. Common problems are: 1) Illegible medication orders. 2) Inconclusive medication orders. 3) Misinterpreted medication abbreviations or dosage. 4) Long turn-around time. 5) Forgotten medication orders on patient charts. 6) Misplaced patient charts. 7) Extra processing time through intermediary nurses and clerks.

On the other hand, medication orders verbally communicated in a hospital setting can lead to more errors during transcription. In the United States, many hospitals have residents, physicians and nurses from different ethnic and cultural background. Everyone has an accent and different proficiency in the command of the English language. Naturally, understanding verbal orders can be challenging at times. Verbal orders are usually given when emergencies arise or when urgent patient care is required. Under such circumstances, pressure and work load greatly increase the potential of medication errors occurring.

Although capable of effectively addressing some of these problems, CPOE systems require drastic changes to existing work processes in a hospital setting. Most CPOE implementation teams have failed to realize that physicians are very busy; they need to attend primarily to patients but also to their pagers, cellular phones, public announcement system at all times. In such a chaotic hospital setting, the last thing to do is to sit a physician in front of a computer screen to fill out medication order forms with many dreadful boxes and drop-downs, spanning multi-page rows and columns! CPOE systems can take significantly more time to capture medication orders than the conventional methods. If a computer system needs to sacrifice physicians' time for medication order data entry in order to reduce medication errors, no apparent value proposition is present. This is the main reason why CPOE systems have not been widely adopted in most modern hospitals today.

Other than the adoption issue, CPOE systems put an unnecessary burden on hospital resources. To deploy such a system in a hospital setting, client software must be installed on computer terminals either at nurse stations or computer on wheels (COW) throughout the hospital. This takes up precious space and requires dedicated maintenance from hospital information technology department. Like most GUI systems, heaps of functionalities are buried in a mountain of menus and controls. Using such a system not only requires substantial training; time is needed before the effectiveness of such a system can be felt, if at all.

At present, most medication orders are written down on patient charts by physician and then faxed to the pharmacy. Only on occasions verbal orders are given and then captured on a web-based system in free-text forms. The orders are then sent electronically to the pharmacy without any completeness check.

In one embodiment of the present invention a Direct Order by Voice Entry (DOVE) method is described. Instead of picking up the phone to convey a verbal order to a nurse in this embodiment the physician or other authorized caregiver call directly the virtual clinical information agent as featured by the Integrated Clinical Information Phone Service. The virtual ICIPS DOVE agent recognizes the medical terminology in the spoken order, checks for missing, data, asks the user to provide additional information if needed and stores the order in a database. It is capable of distinguishing new orders from previously placed orders. It can change and cancel and renew orders. In addition it can be used by nurses to report on the status of order executions, thus providing a tool for completing the prescription/ordering, to fulfillment, to administration loop.

Scenario #7: Physical Embodiment of the virtual clinical information agents.

In another embodiment, instead of ICIPS being a body-less virtual incarnation of the EMR presented by means of a voice-enabled clinical information agent, it can be provided with an actual physical body. One possible instance of such a body is the Remote Presence (RP) robot manufactured by InTouch Health (a USA company based in Santa Barbara, Calif.). An appropriately modified VUI reflects the fact that now ICIPS has physical presence and contains a computer model of its physical presence in the actual environment. In one embodiment it can use the built-in microphone and speakers in the RP robot for communication with stand-by users. In a slight modification one can embed several Bluetooth (BT) audio channels in the RP robot and have MDs and other users during patient rounding to pair their BT headsets. In yet another variation one can use the binaural microphones in the RP-7i to distinguish between a multitude of speaking users gathered around the robot (i.e. solve the cocktail party effect). In yet another embodiment one can incorporate an avatar face with lip-synching abilities and gesticulation in lieu of the real user's face displayed on the robot's head (computer screen with attached video cameras for eyes) when the robot is going for autonomous patient visits.

### SUMMARY

The Voice User Interface featured by integration system can be successfully applied to information systems used in patient care facilities. It can serve as a viable substitution or augmentation of the standard Graphical User Interfaces. In this sense the usage and expansion of integration system is unlimited.

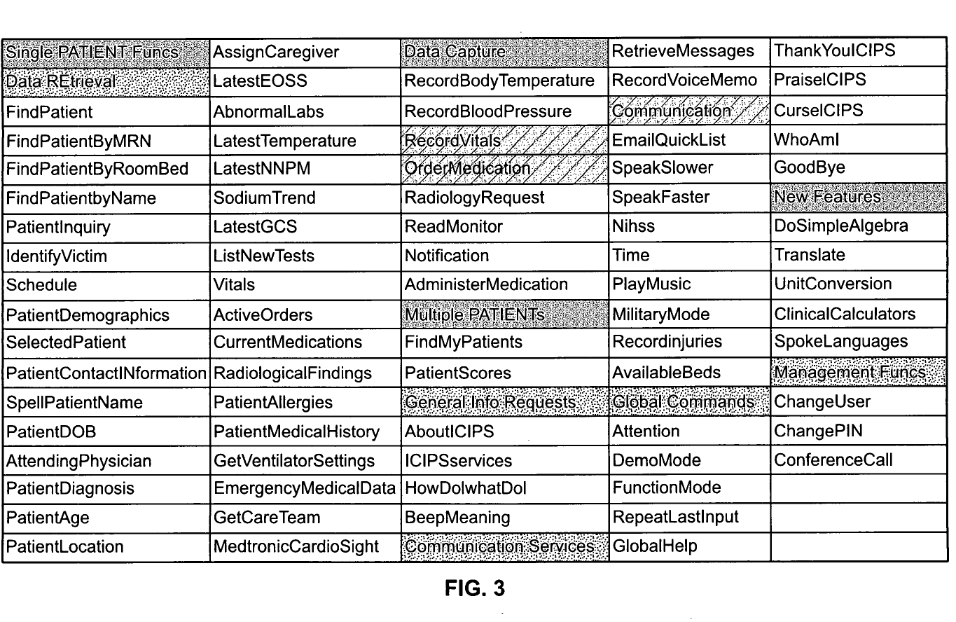

The best mode for implementing the invention is currently to record and time stamped each step of the user's interaction with ICIPS. Also, the clinical information system has a flat architecture with no explicit referral to menus in the prompts. The user logs into the system, has access to over 90 different functions, and the user later logs out of the system. The different functions may include data retrieval functions, data capture functions, general information requests, communication services, global commands, management functions, and new features. Each of the different functions are accessible at the function and aggregately act as a single large menu as seen on FIG. 3.

While certain aspects and embodiments of the invention have been described, these have been presented by way of example only, and are not intended to limit the scope of the invention. Indeed, the novel methods and systems described herein may be embodied in a variety of other forms without departing from the spirit thereof. The accompanying claims and their equivalents are intended to cover such forms or modifications as would fall within the scope and spirit of the invention.

1. A clinical information system comprising:
a) a plurality of user profiles stored in a database, wherein the plurality of user profiles comprise and are subcategorized as physician user profiles, and non-physician user profiles, wherein each subcategory of user has predefined privileges within the clinical information system, wherein physician user profiles are accessed via a login from a physician user, wherein the physician user profile includes a name of the physician user:
b) a telephone system receiving verbal input from a user;
c) a speech recognition engine initiating recognition of verbal input, wherein the speech recognition engine can receive the name of the physician user by verbal input to access the physician user profile;
d) a voice user interface in the form of a virtual clinical information agent, the virtual clinical information agent performing the steps of:
i) receiving voice input via the speech recognition engine, comprising one or more input questions related to patient clinical status;
ii) parsing the one or more input questions and searching a multitude of back-end connected sources of clinical data that are stored in a textual or numeric format;
iii) eliciting no more than one associated answer from each one or more input questions; and;
iv) receiving data input from the user and inputting the data to the back-end connected sources:
v) providing a timestamp for received voice input;
e) a text-to-speech engine converting the response into computer-generated speech, wherein the computer-generated speech is transmitted by telephone to the user;
f) computer memory receiving and storing entered questions, answers, recorded voice data and related text files, wherein the computer memory maintains a record of transaction data that has received a timestamp.

2. The clinical information system of claim 1, wherein the Automatic Speech Recognition engine includes a phone input, and receives continuous voice input during a phone conversation, parsing the voice stream and extracting semantic representations, using the semantic representations to form data queries, directing these data queries to backend data sources via standard protocols.

3. The clinical information system of claim 1, wherein the system is configured to take dictation of messages, and to send the message dictation via email.

4. The clinical information system of claim 1, wherein a menu structure consists of a login menu and a function menu, wherein the function menu has over 40 functions.

5. The clinical information system of claim 4, wherein at least one of the functions provides a backend access to the Medication Administration Record (MAR), wherein the user provides verbal input, and the virtual clinical information agent receives an MAR query and provides an answer relating to the MAR.

6. The clinical information system of claim 4, wherein at least one of the functions provides a backend access to a test ordering portion of the computer memory, wherein the user provides verbal input and the virtual clinical information agent receives a test order.

7. The clinical information system of claim 4, wherein the non-physician user profiles stored in the database further comprise and are categorized as patient user profiles, and physician assistant user profiles.

8. The clinical information system of claim 4, wherein the virtual clinical information agent is configured to receive a trend request as a function, and wherein the virtual clinical information agent provides trend data by comparing past data with present data and summarizing the data in the form of verbal statements to state either that such data is increasing, decreasing or remaining constant.

9. The clinical information system of claim 4, wherein at least one of the functions is a backend EMR access, wherein the physician user provides verbal input relating to patient data, and the EMR data is updated by the virtual clinical information agent.

10. The clinical information system of claim 4, wherein at least one of the functions is a backend access to submit a radiology order, wherein the clinical information system is configured to provide physician user profiles the backend access to submit a radiology order, wherein the virtual clinical information agent receives a radiology order by voice.

11. The clinical information system of claim 4, wherein at least one of the functions is a patient data retrieval function, wherein the virtual clinical information agent finds a patient record by searching using a minimal data set of first name, last name, date of birth, gender, social security number, ethnicity, address or phone number.

12. The clinical information system of claim 4, wherein at least one of the functions provides a backend access to clinical orders also called a Direct Order by Voice Entry (DOVE), wherein the virtual clinical information agent receives a clinical order, recognizes the medical terminology into a spoken order, checks for missing or incorrect data, asks the user to provide additional information needed, and stores the clinical order in the database.

13. The clinical information system of claim 1, wherein at least one of the functions provides a backend access to the Medication Administration Record (MAR), wherein the user provides verbal input, and the virtual clinical information agent receives an MAR query and provides an answer relating to the MAR.

14. The clinical information system of claim 1, wherein at least one of the functions provides a backend access to a test ordering portion of the computer memory, wherein the user provides verbal input and the virtual clinical information agent receives a test order.

15. The clinical information system of claim 1, wherein the non-physician user profiles stored in the database further comprise and are categorized as patient user profiles, and physician assistant user profiles.

16. The clinical information system of claim 1, wherein the virtual clinical information agent is configured to receive a trend request as a function, and wherein the virtual clinical information agent provides trend data by comparing past data with present data and summarizing the data in the form of verbal statements to state either that such data is increasing, decreasing or remaining constant.

17. The clinical information system of claim 1, wherein at least one of the functions is a backend EMR access, wherein the physician user provides verbal input relating to patient data, and the EMR data is updated by the virtual clinical information agent.

18. The clinical information system of claim 1, wherein at least one of the functions is a backend access to submit a radiology order, wherein the clinical information system is configured to provide physician user profiles the backend access to submit a radiology order, wherein the virtual clinical information agent receives a radiology order by voice.

19. The clinical information system of claim 1, wherein at least one of the functions is a patient data retrieval function, wherein the virtual clinical information agent finds a patient record by searching using a minimal data set of first name, last name, date of birth, gender, social security number, ethnicity, address or phone number.

20. The clinical information system of claim 1, wherein at least one of the functions provides a backend access to clinical orders also called a Direct Order by Voice Entry (DOVE), wherein the virtual clinical information agent receives a clinical order, recognizes the medical terminology into a spoken order, checks for missing or incorrect data, asks the user to provide additional information needed, and stores the clinical order in the database.
